(19) United States
(12) Patent Application Publication
(10) Pub. No.: US 2014/0270115 A1
(43) Pub. Date: Sep. 18, 2014

(54) Electronic Message Aggregation and Sharing System and Apparatus

(71) Applicants: J. Stephen Burnett, Wrightsville Beach, NC (US); Paul Wilkinson Dent, Pittsboro, NC (US); Lawrence D. Zirbel, Winter Park, FL (US)

(72) Inventors: J. Stephen Burnett, Wrightsville Beach, NC (US); Paul Wilkinson Dent, Pittsboro, NC (US); Lawrence D. Zirbel, Winter Park, FL (US)

(21) Appl. No.: 13/796,990

(22) Filed: Mar. 12, 2013

(51) Int. Cl. H04M 3/533

(52) U.S. Cl. CPC H04M 3/53325
USPC 379/88.12

(57) ABSTRACT

In one aspect of the invention, a communications device is described to include novel software for aggregating voice and other messages from various communications media and presenting the user with a display of same, ordered by medium, date of receipt, source etc. The software also comprises a user-friendly man-machine interface for forwarding the messages from one medium to another, including making such messages available to members of social websites. In a second aspect of the invention, a server computer is described, including software to receive, organize and store said messages in digital form, with the participation of the user's communication device in one mode and automatically without the participation of the user's device in another mode. The server comprises software that generates links to selected stored messages that the user can post on the Web. When such a link is opened by a web browser, the selected message is made available to the browser and the opportunity to display revenue-generating advertisements to all who access the message is simultaneously created.

### BACKGROUND

The present invention relates to electronic messaging systems and in particular to voicemail systems.

Apparatus for recording telephone calls received when the subscriber is away from his telephone has existed well prior to the development of the Internet and even before the widespread use of digital technology. The earliest systems comprised the use of magnetic recording tape.

With the emergence of cellphones, the now widespread use of digital voice technology allowed cellphone systems to record digitized voice messages in computer-type electronic memory for later replay by the subscriber. Landline telephone systems also now record voicemails digitally in electronic memory. The messages recorded in such electronic memories may actually be transferred back to magnetic media, such as hard disks, which are now much more reliable and have much more capacity than earlier reel-to-reel recording systems.

Voicemail services are most often provided by the landline or cellphone carrier and in those cases the digital voice messages are stored on computer systems located at the carrier's premises. Messages may be offered for storage when a call to a subscriber goes unanswered, or when a second subscriber dials directly into the voice mailbox of a first subscriber to leave a message without ringing the first subscriber's phone. Older technology of answering machines which can be located at the subscriber's premises still exists, the machines switching on automatically when the phone is not answered after a certain number of rings and then answering the call and prompting the caller to leave a recorded voicemail message.

A subscriber accesses voicemail systems in a number of ways. In the case of subscriber-owned answering equipment as just described in the previous paragraph, he simply presses the replay button. Some, but not all, answering machines allow remote access whereby a user can dial in from another phone and command replay by entering a code on the telephone keypad.

In the case of landline phone systems in which the carrier provides the voicemail service, to retrieve voicemails, the subscriber dials a special voicemail retrieval number, which then prompts him to enter his telephone number and a password in order to retrieve voicemails. Other voice prompts may be given to the user to take actions such as electing to save or delete a message.

In the case of cellphone voicemail systems, the procedure has been simplified to merely pressing the #1 key, which causes the cellphone automatically to dial the cellphone voicemail system, and no password entry is necessary, as cellphones already employ sophisticated electronic authentication procedures based on cryptography.

A person may have a number of telephones and therefore voicemail systems by which he can be reached; for example:
One or more home phone numbers (fixed, landline or equivalent via cable or satellite)
One or more work or office phones (fixed, landline)
One or more cellphones (e.g. a personal cellphone and a business cellphone)

The problem that then arises for communicating with such a person is that one would preferably want to know where he is in order to call him. In the case of a wrong guess, a voicemail might be left on a voicemail system which the person may not check for several days. Thus improvements to voicemail systems would be welcomed whereby a message left for a person on any voicemail system would be sure to be promptly retrieved by that person wherever he is.

In addition to the method afforded to the subscriber for retrieving voicemails, namely dialling a specific voicemail number provided by the subscriber's telephone carrier and responding to voice prompts with keypresses to select options, it is possible that certain voicemail servers provide electronic signals on the telephone line to indicate the presence of voicemail messages; however, these signals are not necessarily standardized or published, and are likely to be different between different carriers, or non-existent. For example, it cannot easily be assumed that such voicemail signals, if any, are the same or even known for a telephone located in Mexico or Canada as opposed to the US, but yet it is still conceivable that a subscriber in the US could wish to listen to voicemails left on a phone number in one of those countries.

If a subscriber's service provider of both his landline service and his cellphone service is the same carrier, then that carrier has sufficient knowledge of the operation of both of his systems and sufficient access to them to modify them if necessary to develop a new voicemail system offering voicemail aggregation across all of a user's mobile or fixed subscriptions provided by that same carrier. Systems provided by certain carriers indeed exist to aggregate voicemails from a landline number and a cellphone number, and to make them accessible via the Internet to a fixed computer such as a PC or a mobile computer such as a smartphone. However, there is usually an additional subscription charge for such a service, and it is not possible to aggregate voicemails across different service providers. It is not, for example, possible in the prior art to login to a webpage provided by ATT and see voicemails left on a Verizon phone, or vice versa. Moreover, a 3rd party has not necessarily had access to convenient, documented and standardized digital interfaces with the carriers' servers to provide such a system. Improvements are therefore required to allow a subscriber to aggregate voicemails when, for example, the service provider for his cellphone and landline service are not the same, or when the landline providers for his home and office phones are different. Moreover, in the absence of a single carrier being motivated to provide such a service, it would be desirable if a 3rd party could step into the void and develop such a system.

Other deficiencies of current voicemail systems include occasional unintelligibility of some important piece of information, such as a phone number, left in a voicemail.

Thus means to enhance intelligibility for replay would be welcomed.

Current voicemail systems also do not easily allow messages to be shared with others. In general, once the subscriber has listened to a message, it is deleted unless he elects to save it for a limited time; but there is no convenient means to forward the message to other potentially interested parties. Moreover, the subscriber is periodically required to resave saved messages to prevent deletion. This is inconvenient, as all saved messages must normally be listened to again to resave one of them.

The sentiment has sometimes been expressed that “voicemails are trapped within the telephone system”, making them difficult to extract or share.

If calls are decoupled or untrapped from the phone system and forwarded to a new voicemail service instead, it becomes feasible to contemplate sharing them with others, using social media. Despite the subscriber not then using the phone company's voicemail service, he will most likely not see a reduction in his monthly bill, as voicemail is often bundled with other services.

One method for posting voicemails described in the art is for the user to subscribe to such a new voicemail service, and empower the new voicemail service to post voicemail messages to social media on his behalf. One problem with this method is that there is then little control by the user over where on a particular social site the message will be posted. If the user terminal is a smartphone, it has a small screen that makes it inconvenient to have two webpages open at the same time, one to a social site and another to a voicemail server. Moreover, if the user terminal is a Plain Ordinary Telephone, then it does not display webpages at all. Therefore a single Man-Machine-Interface for retrieving or sharing voicemails does not work conveniently for all types of user terminal and consequently there is a need for new methods and apparatus to overcome the above deficiencies of the current art and to permit the user to retain the voicemail systems provided by his various telephone companies.

### SUMMARY

In a first aspect of the invention, a voicemail aggregation service and apparatus is provided that has the ability to aggregate voicemail messages left on substantially any existing voicemail system for any phone belonging to and designated by a subscriber to the service, including phones having subscriptions for service with different carriers. The apparatus comprises a computer connected to the internet and, if necessary, to phone lines, in such a way that it can be accessed by subscribers to the service to retrieve, save, delete or share voicemails or other messages, the computer in turn being able to access the subscriber's existing voicemail systems either by phone or internet connection, as appropriate. When the user authorizes the inventive apparatus to aggregate his messages automatically, he provides all the credentials necessary for the apparatus to access his message systems to retrieve and store messages. The description herein is principally directed to explaining how voicemails are handled, although it may be realized that the principles disclosed may also be applied to other message systems such as e-mail, in which the attachments may comprise text, audio or images. If the use of videophone becomes more widespread, and voicemails follow suit and include video images as well as audio, the system described should be understood to be easily generalized to include multi-media messages.

When necessary for a particular existing voicemail system, the inventive server parses the complete voicemail replay from that system automatically into individual messages, when the voicemail system itself does not provide such a facility, and stores the individual messages as separate, annotated files in a suitable audio file format such as .WAV. The subscriber may then log into the inventive apparatus to view all voicemails that have been aggregated together from all his voicemail services, including those provided by different, unrelated telephone companies, and the subscriber may retrieve a hyperlink to any of the aggregated voicemails selected by him. The subscriber may then post the link to other media, such as by embedding it in an e-mail or by posting it on a social site at a location on the social site selected by him extemporaneously, thereby making the message available to other parties. In order to perform the latter with the minimum number of keypresses, a second aspect of the invention comprises inventive software (an “App”) that may be downloaded from the inventive server to the subscriber's smartphone or computer, the inventive App providing a convenient man-machine interface by which the user may, in one implementation, click on a displayed symbol to select the message, a link to which to insert into an e-mail or post to a social site, the App then performing automatically the steps of retrieving the active link IP-address byte string from the voicemail server and embedding it where designated. In another implementation, while composing a post on a social site using an editor, the user may select an option from a dropdown list provided by the editor to insert a hyperlink to a voicemail, the App then performing automatically the steps of displaying a selection of voicemails in a pop-up window, noting the voicemail selected by the user, closing the pop-up window and then retrieving the hyperlink string from the inventive voicemail aggregation server and embedding it where designated.

When other parties log into the social site and click on the link, the opportunity is presented for the inventive server to deliver revenue-generating advertisements in a way that is unobtrusive to the objective of accessing the message. This enables a basic version of the service to be provided to many subscribers free of charge.

In addition, a man-machine interface may be provided that enables the user to instruct the inventive server to make quality-enhancing edits to stored audio files in order to improve intelligibility, such as the ability to partially rewind and replay a section, change the volume or frequency response, or process out background noise using any suitable noise reduction algorithm.

A novel piece of hardware is also described, comprising an internet-attached answering machine which facilities the task of collecting voicemails in otherwise intractable cases where no voicemail service from the telephone carrier is available.

### BRIEF DESCRIPTION OF THE DRAWINGS

FIG. 1 illustrates a simplified sequence of voice prompts that occurs in accessing a conventional wireline voicemail service

FIG. 2 is a block diagram of an inventive server architecture for performing message retrieval from unrelated message systems.

FIG. 3 shows the information flow for posting a voicemail to social media.

FIG. 4 shows a web-appliance for untrapping voicemails

### DETAILED DESCRIPTION

For conciseness, a number of contemporary expressions are used herein, which are defined as follows:

An “App” means an Application Program which can be selected to be installed by a mobile phone user on his mobile phone after manufacture, for example by downloading it from the Internet. An App may be free, or might be provided upon payment of a nominal sum of money by credit card or online payment service such as PayPal. The term “App” is also used herein to apply to such programs intended for fixed computers such as Personal Computers (PCs) or portable computers such as laptops, IPADs or Tablets.

An “OS” or operating system means the lowest level or core software provided on a user terminal such as a PC or smartphone, one purpose of which is to provide a level of abstraction to mask hardware differences between different device from higher level software. The OS usually provides a number of reasonably well documented APIs or Application Program Interfaces that another programmer of higher level software can use without being concerned about hardware differences between different devices.

A “server” is a computer or bank of computers connected to the Internet, the purpose of which is to transmit digital data over the Internet simultaneously to multiple user terminals that are browsing the internet, the data representing webpages, movies, sounds, text or any other form of information that can be represented digitally. The webpages may be fixed or dynamically composed depending on the application and depending on the intended user destination.

A “carrier” or “service provider” means an entity licensed by the FCC in the US or equivalent organisation in a foreign country to provide telecommunications services, typically telephone services, to the public in that country in return for payment.

“Voicemail system” or “Voicemail service” means an arrangement associated with a telephone number to record calls received when a call to the number goes unanswered.

“Call forwarding” means an arrangement associated with a telephone number to redirect a call to a different, predetermined telephone if calls to the number go unanswered. Thus the subscriber must choose whether he wants unanswered calls to a given number to go to voicemail or to be forwarded to another telephone.

“Social Media” or “Social Sites” refers to any website which a user might log into or visit to exchange messages with others having like interests. E-mail services may be considered to fall within the definition of “Social Media”. Facebook, Linked In, Myspace and suchlike websites are examples of “Social Sites”

A “hyperlink” means an Internet address (IP address) that directs a web-browser to data stored on the same or a remote computer which is accessible over the Internet. A hyperlink may be identified to a reader by a visible, human-meaningful text string while having a hidden, computer-meaningful web address string.

“Skype” refers to a well known brand of Voice-over-Internet services which allows telephone calls to be placed via a digital internet connection rather than an analog telephone line. The calls are converted between analog and digital at the Skype caller's location, transmitted digitally over the Internet to a Skype concentrator local to the area of the called number, and then converted between digital and analog once more for delivery over the local analog telephone network if the called subscriber is not also a Skype user.

In a first aspect, the invention comprises an inventive voicemail aggregation device which is described further later with the aid of FIGS. 2 and 4, which may have adapters configured to interface with every voicemail system designated by a registered subscriber, even when those voicemail systems are provided by different carriers. The inventive voicemail aggregation device collects voicemails left on any of the subscriber's voicemail systems for any of his designated telephones, even when those telephones are served by different carriers, or, in the absence of a telephone having a voicemail service, the inventive voicemail aggregation device can perform collection of a voicemail itself by having unanswered calls forwarded to it, or, if the device is co-located and associated to the telephone, may forward the voicemail message to another device for storage, optionally after temporarily recording and storing it itself. It may be appreciated that devices that communicate digital information may incorporate buffer memories of any size to bridge timing differences between the operation of one device and the operation of another. At one extreme, data received by one device corresponding to a digitized voicemail message may be substantially immediately forwarded to another device, while at the other extreme an entire voicemail message may be recorded in buffer memory before forwarding to another device. The choice of buffer size is not material to the invention, and is selected based on timing considerations.

A second aspect of the invention comprises an App which may be downloaded to a mobile phone, fixed PC, Tablet, IPAD, laptop or any other suitable fixed, portable or mobile user terminal, the inventive App providing a convenient Man-Machine-Interface by which the user can cause the combination of his terminal and the inventive voicemail device to perform a variety of useful functions, such as displaying all voicemails received and selecting to listen to, save, delete or share them.

A third aspect of the invention comprises using the inventive App and the inventive voicemail aggregation device to post on Social Media a hyperlink to a selected message left by a second party for the first party (the subscriber) and which is stored on the inventive voicemail aggregation device such that, upon another internet user (a third party) reading the post and clicking on the hyperlink, the message is transmitted and played or displayed to the third party. A device which presents webpages over the internet simultaneously to many web-browsers is commonly called a “server”. One implementation of the invention comprises using such a server, which can be established by a party other than a telephone service provider to provide an inventive voicemail aggregation service to registered users.

A fourth aspect of the invention comprises displaying advertisements in a pop-up window on the third party's user terminal when the third party clicks on the hyperlink posted on the social medium.

Each of the above aspects may furthermore have an inventive apparatus aspect, an inventive software aspect, an inventive method aspect and an inventive business aspect.

The invention may comprise in the first aspect an internet server having adapters, which are described further later with the aid of FIG. 2, and which are configured to interface with every voicemail system used by a subscriber, including voicemail systems provided by different, unrelated telephone service providers. The following description is an example of the functions performed by such an adapter in an exemplary case.

FIG. 1 shows the typical flow diagram for navigating through a voicemail retrieval system using voice prompts. Voicemail systems belonging to different operators may exhibit a different flow, but the example used is based on a simplified form of the voicemail provided for landline phones by ATT, which was formerly established by Bell South.

In the absence of a more efficient method, the invention aims automatically to perform the actions that would be performed by a human subscriber to navigate through the state diagram of FIG. 1. In a first implementation, this action may be performed by using a computer program or “App” installed on a computer or smartphone belonging to the subscriber. When installed, such an App picks up software hooks to the keyboard and display Application Program Interfaces (API's) provided by the Operating System (OS) and gets access to all the communications APIs likewise. In a second implementation, the subscriber delegates this action to be performed by the inventive server by providing it with the credentials necessary to log into his voicemail systems. The use of one implementation or the other may be selected on a per-subscriber and per voicemail system basis depending on which is most suitable for his voicemail systems or personal preferences.

Referring to FIG. 1, in the first implementation, upon the user clicking on a “Get voicemail” Icon, the App starts executing at step 100. Alternatively, a timer can be set to determine a periodic polling for new voicemails. In the case the voicemailbox in question is for the mobile phone on which the App is installed, the mobile phone may receive an alert when a new voicemail is available, the alert being intercepted by the App and causing it to take the desired action, thus obviating the need for periodic polling. The App has a predetermined method to use to access each voicemail service. In the example under discussion, this might be to place a call to a prestored number. For example, for an ATT voice mail service for a phone located in the center of North Carolina, the number to be called is 919 918 2095. The smartphone or other user terminal thus rings this prestored number in step 100. The smartphone waits for an answer in step 110. When answered, cellphone and other phone systems provide specific signalling to indicate when a call is answered. If the call is not answered within a timeout period, transition is made to step 115 which clears down the call, then in step 117 the number of retries is counted, and a return to step 100 to try the call again is made if the number of retries is within a preset limit. If on the other hand the signal is received that the call has been answered, transition is made to step 120 where a voice recognition algorithm listens for a prompt to enter the subscriber's phone number associated with the voicemail system. For simplicity, a number of steps that may be needed at sign-on have been omitted from this exemplary voicemail flow diagram. Upon detection of the appropriate voice prompt, transition is made to step 130 and the subscriber's prestored phone number is issued by DTMF tone signaling or its digital equivalent.

After issuing the phone number, at least two possible outcomes could be anticipated. One possible outcome is that, for one reason or another, the phone number is not recognized as valid. Another possible outcome is that the phone number is accepted. The voice recognition algorithm continuously attempts to detect both of the predetermined announcements for these two possible outcomes and ultimately decides which outcome occurred. If the phone number was deemed invalid, a return is made through steps 145 and 135 to re-enter the phone number, with the number of retries being counted at step 135. After K2 unsuccessful tries, the call is cleared down at step 115 and the call may be re-dialled. If the phone number was deemed valid however, detection of the prompt for a password advances the state to step 150 where a password will be issued by DTFM signalling or its digital equivalent. At step 160, two possible outcomes can be anticipated; either the password is deemed invalid at step 160 with consequent backtracking through step 167, or else the password is accepted, in which case the voicemail system will either announce that there are no messages, or that there are a certain number of messages. The voice recognizer correlates for both possibilities and if the “no message” announcement is detected at step 190, the call is cleared down at step 200 and the algorithm stops. On the other hand, if the voice recognizer detects the announcement that there are messages, this preferably merely triggers recording in memory of everything from that point until a termination criterion is detected, for reasons outlined below. The termination criterion might be the voicemail system clearing down the call upon receiving no further instructions.

Navigating a voicemail system's state diagram by means of machine-understanding of voice prompts is the most ambitious goal of the invention. This is one way to collect voicemails with little or no user intervention from conventional voicemail systems that provide only this form of access, and no web-based, machine-navigable, server-based access. A fallback position in the case a particular voicemail system is difficult to navigate by machine is to enlist user assistance to recognize the voice prompts and to initiate recording and termination of each message by pressing keys. This can be made very convenient to use with few keypresses. Specifically, the user is relieved of having to enter the 10-digit number of the voicemail system; is relieved of having to enter his own 10-digit phone number, and is relieved of having to enter his password for the voicemail system. In the worst case, the user may be required to press a key indicating when he has understood the end of a voicemail message to have been reached or a new voicemail message to have begun. Enlisting user support to mark the beginning or end of voicemail messages in this way has been described in the prior art for the purposes of assisting a speech-to-text conversion of a voicemail message. In the present invention however, it would be used to assist in parsing the voicemail replay into individual messages for the purposes of causing each to be stored, still in digital audio form, in a separate file in memory.

Achieving the goal of full automation of voicemail retrieval, parsing into individual messages and removal of system voice prompts is however facilitated by the following insights:

(1) The voice prompts of a particular voicemail system are always exactly the same, spoken by the same voice at the same speed. This considerably improves the reliability of voice recognition for detecting them.

(2) Sophisticated soft-decision algorithms based on Markov Chains may be used, whereby instead of hard decisions as to what state has been reached, all possibilities are maintained in parallel, probabilities for each state are computed, and the state having the highest probability is ultimately selected at some suitable terminal instant.

(3) The ultimate goal of partitioning the entire voicemail replay into individual messages, extracting the time and date of receipt, and creating a file for each may be considerably simplified by relegating this task to offline processing wherein the stored audio dialog may be processed and reprocessed as many times as required to decode and parse it properly. Moreover, this offline processing does not need to be carried out in the smartphone or other user terminal, nor in real time, but may be carried out in an inventive voicemail aggregation device constructed according to the teachings herein. When the inventive voicemail aggregation device is a remote server, a user terminal may first record an entire voicemail system replay and then convey the whole digital recording automatically to the server over an Internet connection. Alternatively, in the second implementation, the user enables the server automatically to access his voicemail system directly by phone line or Internet to perform the task of parsing the replay into individual messages, for example by first recording the entire voicemail system replay and then parsing it by offline processing.

The goal of the offline processing of the entire replay recorded from a voicemail system is to partition the whole recording into individual messages, extract the time and date of receipt announced for each, and store each message in a file in association with its time and date. In some cases, the calling party may also be identifiable. The above is the function performed by one type of inventive adapter designed to navigate an existing voice-prompt voicemail system, when no other interface is available.

The above exemplary existing voicemail system announces replay of the first voicemail in the following way:

“First message, received Saturday December 12 at 3:25 PM”.

There then follows the actual first voicemail. At the end of the each voicemail, there may be an option to callback by pressing 1, to save by pressing 2 or to delete by pressing 3. As the message is being recorded by the invention, it would be appropriate always to issue a “3” upon detecting this prompt, which would however then have to be done in real-time. To avoid this real-time voice-prompt understanding task however, if no option is selected, the exemplary system does continue on to the next message after a short pause. At the end of all voicemails, the “replay” option may be selected to pass through the voicemails again, deleting them very quickly. Deleting messages that have already been recorded by the inventive voicemail aggregation server is desirable to avoid them being processed again upon a subsequent access to the voicemail system. Alternatively, voicemails already replayed and stored could be deleted the next time the invention accesses the voicemail box, after having processed the original recording offline to properly decode the number of voicemails and having parsed the replay into individual messages. Thus three options have been disclosed above for deleting voicemails from the carrier's voicemail system after recording them on the inventive voicemail aggregation server. Different carriers' systems may work more efficiently with one deletion method than with another. The selection of which method to use would be predetermined based on each voicemail system, and the determined method implemented in the adapter for that system.

After each voicemail is replayed, the exemplary voicemail system follows right on by announcing the next message similarly, if there is one. Voice recognition would attempt to extract the number of the message, verifying that it is sequentially one higher than the previous message, and the time and date of the message, verifying that it is later than an earlier message. The check for sequential message numbers and date/times provides a way to recognize mischievous attempts to fool the machine by sending a voicemail which is the recording of the output of another voicemail system replay. This in turn could contain a message which was the replay of another voicemail system replay, and so on ad infinitum. The audio stream of such a message would comprise valid system announcements but would exhibit out of sequence message numbers and non-sequential dates/times. If a message with a given number is detected twice in the audio stream, then the machine must determine which was the message and which was the message within a message, and the date/times can provide the clue to correct parsing. How much effort need be spent on making a system immune to such mischief is however debatable, but has been considered because the envisaged inventive server specifically provides the facility to forward messages from one voicemail system to another.

If real time detection of the prompt to delete, save or replay is the method chosen to delete already recorded messages, and the message within a message contains such a prompt, then at least the mischievous message will be deleted in its entirety early through its replay.

It is desirable for an offline parsing algorithm to be robust and reliable, and this is facilitated by the ability to process and reprocess the entire recording as many times as necessary with no real-time constraint.

Within a voice recognition algorithm, dynamic programming is usually employed to match each short audio segment with each of the possible expected audio prompt segments, and a mismatch factor, similarity factor or match probability factor is computed, which we denote by the general expression “delta metric”. Each possible position part way through the expected audio prompt is also given a cumulative metric, which is the accumulation of the delta metrics along the best path leading to that point.

Upon the matching algorithm path reaching an end point of a predetermined prompt, the cumulative metric is an indication of the reliability with which the prompt was detected. This is compared against the reliability of all other possible prompts and that which has the greatest reliability is used to initiate an instance of the subsequent action to be carried out. Several instances of the same subsequent action may be initiated at different times and accumulation of metrics continues from the previous value. A path which was initiated too early may fail to exhibit a high continued metric accumulation and will thus be overridden by a path that was initiated at a more optimum instant.

The operation of dynamic programming algorithms for the recognition of continuous, connected speech as well as isolated words has been known for several decades, and is further described in the following reference:

“Dynamic programming search for continuous speech recognition”., Ney, H and Ortmann, S, IEEE Signal Processing Magazine, Volume 16, Issue 5, September 1999, pages 64-83.

Syntactically constrained voice recognition is also known and developed in the art, in which sequences of words are limited to grammatically allowed sequences. In general, voice recognizers may contain “silence” of indefinite length as one of the allowed audio segments or “words”, so that gaps between words are recognized and correctly handled. Allowed sequences form Markov Chains, in which transition from one word or node in the syntactic state diagram to the next occurs with propagation of and accumulation of node probabilities.

When an error is made, such as issuing a phone number when a password was required, or vice versa, a different page of the state diagram/Markov Chain is entered that is constructed to represent the voicemail system's behavior in that event. Having different pages of Markov Chains/state diagrams corresponding to different erroneous action by the adapter at different places in the voicemail system's state diagram expands the total state diagram significantly, but still well within the capability of even a small processor by today's standards, and does not add much to the processing power required, while greatly improving the ability to recover from an error.

When voicemails are automatically retrieved from unrelated voicemail systems with the aid of a smartphone App as above, the user can determine how often the App should check for new voicemails on each voicemail system. Each smartphone deals with only one user, thus there is no bottleneck.

In the second implementation of this aspect of the invention, the user can require a remote server belonging to a voicemail aggregation service constructed according to the teachings herein, and on which he is registered, to perform the polling for new voicemails. In this case, the server performs this function for a large subscriber base, with the result that bottlenecks can arise. For example, if the server were to place calls to voicemail systems by wireline, and the users had requested polling every 5 minutes, and it took 1 minute to determine that there were no new voicemails (which would be the case most often), then the number of telephone lines required would be ⅕th the number of subscribers, which is excessive. Fortunately, calls to landline numbers can be placed over the internet, using for example Skype.

Skype-type systems have placed concentrators in each dialing code area which are connected to the Internet at one end and to the local telephone system at the other. Thus a call can be directed over the Internet using Voice-Over-IP to a concentrator in the local area of a called number in order to bypass the long distance part of the telephone system. Thus the inventive voicemail aggregation server may comprise multiple instances of Skype-like software running simultaneously to allow a large number of simultaneous calls to landline voicemail system numbers without incurring the cost of long distance calls. Such a multi-number, Voice-over-IP system is sometimes known as an Asterisk Server. In the method of collecting voicemails by having unanswered calls forwarded from another operator's phone system, an Asterisk server can be used to receive the forwarded calls. By contrast, when the inventive voicemail aggregation server periodically polls other operators' voicemail systems, the Asterisk Server is being used to initiate multiple calls.

It will be understood by those skilled in the art of software that programs such as Skype-like VoIP software or voice recognition do not need to be duplicated in computer memory to provide several operational instances executing simultaneously, providing that the software is re-entrant and that each instance has its own data segment and stack segment. Thus an Asterisk Server can be used both to initiate polling calls to any phone system's voicemail number while simultaneously receiving forwarded calls from the same or a different phone system.

Thus when the inventive server activates an adapter to access a subscriber's Voicemail system and navigates through it, it preferably merely records the entire replay and then parses it into individual messages by offline processing, exactly as in the previously described first implementation where the smartphone participated in collecting the voicemail replay.

Some voicemail systems may provide better ways to access voicemails than via a dial-up number.

For example, it is possible using an Internet-capable smartphone or PC to visit the web page of certain carriers, enter a user ID such as a telephone number and a password, and view voicemails for numbers provided by that carrier on line, and select which to replay. It is also disclosed in the prior art that a smartphone may display voicemails that have been received on the voicemail systems of different carriers; however, in this prior art the user had to manually place a call to the voicemail system of each carrier to listen to a voicemail left on that carrier's voicemail system, and the voicemail was still “trapped within the phone system”.

It is also not known in the prior art to visit the webpage of one carrier to retrieve and replay voicemails left on another carrier's voicemail system; therefore automatic voicemail aggregation across multiple carriers' voicemail systems was not available. This problem is solved by the invention, which, in the last resort, uses a voice recognizer to navigate through the voicemail system's state diagram by recognizing voice prompts in order to perform the actions which a human subscriber would have done to listen to his voicemails. This must of course always be available to a subscriber, and therefore to an automaton mimicking the actions of a subscriber.

A more efficient voicemail retrieval system may be implemented If a documented digital interface exists with the voicemail server belonging to a particular telephone service provider, or for which the operation has been deduced though reverse engineering by a skilled and determined hacker.

Such a digital interface may be web-accessible and may provide voicemail header information such as the number of and identity of each voicemail, as well as separately selectable access to each voicemail, thus eliminating the need to use a voice recognizer for parsing voicemail replays for that system. This represents a second type of adapter that can be constructed for pulling voicemails from an existing voicemail service. Thus each voicemail system requires a particular, customized adapter to retrieve voicemails from it, based on the availability to 3rd parties such as the current inventors of documented or reverse-engineered interfaces to the voicemail system. Each adapter may have a corresponding section of software code in the inventive App that is downloaded and installed on a registered user's terminal and with which it may collaborate to perform the operations described above and herein below.

The registered user may wish to retrieve voicemails using different terminals, for example using a mobile phone sometimes, a PC sometimes or a Plain Ordinary Telephone (POT) at other times. The inventive voicemail aggregation server provides the greatest functionality to the user when accessed by an intelligent terminal, but may also, using the Asterisk type server mentioned above, provide multi-line dial-in access for POTs with reduced functionality.

In the case that a particular telephone system provides no voicemail service at all, but allows call forwarding, the inventive server can include a third type of adaptor that implements a multi-number, Voice-Over-IP telephone terminal that records calls that go unanswered. While this could be used for all telephone systems, the subscriber would not then necessarily know by which telephone number a caller had attempted to reach him. This may be solved by having a different forwarding number for each of the subscriber's telephones. The inventive server can then aggregate the voicemails from all such forwarding numbers, as all the forwarding numbers are implemented on an Asterisk server within or colocated with the voicemail aggregation device and commonly developed and owned. The voicemail aggregation device can associate the forwarding numbers to the subscriber's various telephone numbers for display to the subscriber. The choice of forwarding unanswered calls to the inventive server or enabling the inventive server to pull calls from one of the subscriber's existing voicemail services is however left by the invention to the subscriber to decide. In the case that one registered user using a cellphone or other suitable user terminal wishes to leave a voicemail message for another registered user, it is possible to offer “HiFi” voice, that is a voice coding method using a higher bitrate and not restricted to the 3.4 KHz of the telephone network or to the use of a low-bit rate vocoder. For example, voice messages may be left on the system using 16-bit PCM at 16 kilosamples per second, assuming that the user terminal has the ability to digitize speech at such a rate and to make it available to the App before compression.

Before the current invention, it was not possible to visit the web page of one carrier and see voicemails from a different carrier. The current invention may be implemented by a party other than an existing telephone service provider however, and by performing collection of voicemails across all carriers to the inventive voicemail aggregation server, allows the user to visit a single web page provided by the inventive server to view, select, listen to, pause, fast-forward, partially rewind, replay, quality-enhance, delete or share all voicemails. The inventive server can permit the user to sort the list of voicemails for display by any or all of
date and time of arrival
calling number (if known—not all voicemail systems will betray that)
called number on which the unanswered call was received

Furthermore, and in particular, the inventive server provides the facility for the user to share any voicemail with others by posting a hyperlink to it on any suitable internet medium, such as by embedding the hyperlink in an e-mail, or posting it on Facebook or other social site or “blog”, using a simple man-machine interface.

Upon logging in to the inventive voicemail aggregation server using a suitable user terminal such as a PC, the server will deliver a webpage to the web browser of the subscriber's terminal which is composed individually for each subscriber to display his messages.

One man-machine-interface for posting a hyperlink to a selected voicemail in an e-mail or to a social site or blog can be to drag and drop the symbol, icon or text string displayed for a voicemail in the list to an edit box that is already open for message composition. While this can be convenient when using a large-screen terminal such as a PC, it is not so convenient to have two web pages open simultaneously on a small-screen smartphone.

Consider the following two tasks in which the subscriber may be engaged:

(A) He is looking at his list of voicemails and decides to post one to Facebook

(B) He is on Facebook and decides to post a voicemail there

In the first case, scenario (A), a prior art proposal is to pre-load the voicemail server with Facebook login credentials, so that when the user is looking at his voicemails, he can select an option to “post to Facebook” and the server automatically performs the task of posting a voicemail. However, the disadvantage of this prior art is that the user has no choice over where it goes. Using Facebook nomenclature as an example, there is a location on a user's Facebook page called “user status” that the prior art may have envisaged as being the default location to which the voicemail server would post a voicemail. However, that might not be where the subscriber intends. Other possible intended locations could be to the “wall” of any one of a large number of friends, or to a reply composed to any one of a large number of other posts on Facebook. It would be so cumbersome as to be impracticable to have preloaded every possible such location to the voicemail server, and even if this were done, no method has been proposed in the prior art for selecting between them or for dynamically updating the list as Facebook acquires new messages to which replies may be solicited.

On the otherhand, if Scenario (B) is considered, the subscriber is already logged into a selected social site and is positioned at an ad-hoc selected location on a selected webpage, such as reading another friend's wall, or composing a reply to a selected message, when he decides to post the voicemail link to that location. The user has thus already selected where a hyperlink to the voicemail should be inserted and it remains to select the voicemail in question. According to the current invention, this is done by providing an editor which has an “insert” option that, when selected, opens a dropdown box with “voicemail” as one of the options. When this is selected, a new window opens temporarily to display the list of candidate messages, which would be obtained by accessing the inventive voicemail aggregation server, if the list is not already downloaded to the user terminal. Upon clicking on one of the candidate messages, a hyperlink to it on the server is solicited from the server, generated by the server, transmitted by the server to the user terminal, and inserted by the editor in the designated place in the message being composed, the voicemail selection window then closing to avoid obscuring the user's original message composition task, which may be on a small smartphone screen.

Thus different Man-Machine-Interfaces are required for Scenarios A and B. For scenario (A) a convenient method for use with a smart phone is to provide a drop down list when clicking on a voicemail, offering the user the options of:
Listen
Delete
Post to Facebook
Send by e-mail
Post to site xyz etc

but the options for posting are necessarily limited. For a large-screen PC, on the otherhand, it is possible to have both the voicemail webpage and the Social site webpage open at the same time, in which case dragging and dropping a symbol, icon or string from the voicemail page to the Social Site page is possible and convenient.

For scenario (B), while composing a message, a convenient method is to select “insert” from the editor toolbar, a dropdown box then appearing with the options of inserting, for example:
Special character
Picture, movie or other multi-media file
Hyperlink
Link to voicemail, etc.

In all these cases, the current invention uses the user terminal to effect the transmission of the message with the embedded voicemail link to the selected social website, in contrast to using the voicemail server to communicate directly with social site to perform the posting, with the attendant disadvantages outlined above.

Thus for Scenario B, upon selecting the option to insert a hyperlink to a voicemail within the editor, the editor invokes the inventive App to communicate with the voicemail aggregation server as necessary to temporarily display a list of voicemails to the user, the selection of one of which causes a hyperlink to the selected message to be solicited from the server and inserted by the editor at the place already opened by the user and where the composing cursor was last positioned. It may be noted that the composing cursor, usually a blinking bar or square in the current character position of a message under composition, is different than the mouse cursor, which may be independently moved to select “Insert” from the editor toolbar without changing the position of the composition cursor in the message.

A hyperlink comprises plain text bytes that are visible to a human reader as well as hidden bytes that describe the IP address of the link and which are only intended for computer use. For example, the visible text bytes may be:

“Mary's birthday greeting”.

while the invisible IP address part of the link might be:

href=“https://www.sharemailinc.com/ef2xstgyklr569.jsp”

or something even more cryptic.

The link might be embedded in a text message starting with “Listen to” so that a person reading the message sees

“Listen to Mary's birthday greeting”

The words “Mary's birthday greeting of the hyperlink would usually appear in blue and be underlined to indicate to the reader that this is a clickable link.

The invisible part of the link directs the web browser of a person clicking on the link to a pre-prepared computer object on the voicemail server which is downloaded to the terminal of the user who clicked on the link, and who is not necessarily either the user who posted the link or the subscriber who left the voicemail, but more usually is a third party. The downloaded computer object may be a program written in html or javascript or any other language or mixture of languages which is executed for example by a java virtual machine on the user terminal to perform any one of a number of actions in addition to playing the voicemail audio file through a media player. One of the actions for example can be to verify that the link was clicked within the same web page to which it was originally posted as a method of restricting the audience to the originally intended subset. The current webpage on which the link was clicked may be retrieved by the App using one of the browser APIs provided by the OS. Thus the inventive App may convey information to the voicemail aggregation server in addition to the hyperlink string to facilitate this authentication. Likewise, during message composition, when a voicemail hyperlink is solicited from the server, the location where it will be embedded may be sent to the server as well as an indication of the selected voicemail, so that the server can generate a site-specific hyperlink.

Thus the inventive server stores both the human-readable text entered by the subscriber and the non-human-meaningful data it generates for the link to be posted. The owner of the voicemail aggregation registration may at any time edit the human-readable text that identifies a message by logging into the voicemail aggregation server and performing an edit function on this item in his tabulated message list.

Another action which can be performed at a third party's terminal upon clicking a hyperlink can be to open a pop-up window to display a prestored picture (mugshot) of the message originator, also downloaded from the server. The owner of the voicemail aggregation registration would have had to have provided this image when logged in on a previous occasion.

Yet another action that can be performed at a third party's terminal upon clicking the voicemail hyperlink is to open a pop-up box that displays an advertisement while the voicemail message is replaying. The window may close automatically upon the voicemail message terminating, or alternatively manually closing the window may terminate the replay of the voicemail message. Thus a 3rd party other than a telephone carrier may implement a basic voicemail aggregation and sharing service free of charge to many registered users, the service being paid for by advertising revenue. The advertising aspect of such a service may be characterized as displaying advertisements to a third party who clicks on a hyperlink to a voicemail left by a second party for a first party on any of the voicemail services to which the first party is a subscriber and which was shared in a post to a social site by the first party.

The inventive voicemail aggregation and sharing server also allows a previously shared voicemail to be retracted. If a message had already been posted to a site such as Facebook for example, the registered user of the voicemail aggregation and sharing service can be presented with a display of the sites to which he had already posted each message, and upon clicking on a site associated with a voicemail, the option “Retract from (site name)”. can be offered. By generating separate hyperlinks for each site to which a message is posted, it is possible to retract from one site while leaving the message accessible on another site. For example, the message could be retracted from being accessed by a multitude of friends on Facebook while being left accessible in an e-mail to a particular friend. The computer method by which this may be achieved may be alikened to “double indirect addressing”. The hyperlink would first direct the browser to a site-specific link in the inventive voicemail aggregation server. The site-specific link would contain the actual address to the voicemail file on the sever. However, upon retraction of a message from a specific site, the site-specific link can be replaced by a link to a page which says, in text or voice “This message has been deleted (or retracted)”

Thus because the inventive server does not post the audio file, or even a link to the audio file, but rather a link to a link to the audio file, which can be unique for each destination if desired, it is possible to retract an already posted message by having the server replace the target pointed to by the link with something other than the original message. The message is still stored in the server however, but that particular link no longer points to it. The link to the same message posted on other media, such as embedded in an e-mail, can however remain, as it can be a unique link for each possible posting destination. Knowing the site to which a message has been posted can also enable the server to deliver site-specific advertisements to a third party clicking on the hyperlink.

The information flow for posting a voicemail link is shown in FIG. 3. Three devices are involved: User terminal (1010); the inventive voicemail aggregation and sharing server (300) and the social site server (1000). Communications between these devices are illustrated by jagged arrows for simplicity, but it may be understood that such communications may take place over a variety of communications networks, including the Internet, to which access may be achieved by landline, cable, satellite, WiFi point or cellular mobile communications network as examples. It may be seen that there are no direct communications between the voicemail server and the social site.

In accordance with Scenario B, the user may have already logged in to social site (1000) by providing login credentials as part of the user terminal to social site server communications 1013. The user may also have navigated to a webpage on the social site and may be engaged in composing a message at a selected location on the webpage by use of an editor. Upon the user selecting to insert a link to a voicemail in a manner such as described above, the user terminal may transmit a request (1020) for a list of voicemails stored on server (300), if such a list is not already to hand and up-to-date. Server (300) replies by sending the list (1021) which is received at the user terminal and displayed in a pop-up box. The user than clicks on a voicemail displayed in the pop-up box, which causes the user terminal to transmit a request (1011) to server (300) bearing an indication of the selected voicemail and optionally an indication of the social site location on which it shall be posted. The latter indication is not a limiting element of the invention but is interesting due to the ability of sever (300) then to generate site-specific hyperlinks to a selected voicemail for the purposes of implementing the site-specific retraction feature described above. The server (300) then transmits the generated hyperlink string in communication (1012) to the user terminal. The editor that is open for composing the message to be posted then inserts the hyperlink in the message where indicated by the composition cursor. Upon completion of the message composition, the user causes the completed message bearing the hyperlink to the selected voicemail to be transmitted to the social site as part of user-terminal to social-site communications (1013). Social Site (1000) thereafter displays the message in such a way that 3rd parties may click on the hyperlink to listen to the voicemail. The hyperlink directs the web-browser to the indicated address on server (300) which is a pointer to a computer object that will deliver the voicemail to a media player linked to the web browser and also deliver one or more advertisements or other pictures and text for display while the voicemail is being replayed.

For scenario A, at registration and at any time thereafter, the user would have the option to indicate to the App stored in the user terminal, or to the server (300), or both, the different ways in which he could envision sharing the message, but would not need to perform the step of providing the voicemail aggregation server with login credentials to Social Sites. Instead, the login credentials are stored in the user terminal and made accessible to the inventive App which communicates with the voicemail aggregation server as just described for scenario B. The App is thus aware of the selected site for posting and uses the logon credentials to cause the user terminal to access the site to post the selected message with an embedded hyperlink provided by the server. The difference between scenario A and scenario B is that the user may transmit the request for voicemail list 1021 to voicemail aggregation server (300) before logging into social site server (1000). The user then selects the option to post a selected voicemail to social site (1000) from the options provided by the voicemail list display page, which can include save, delete, post to Facebook etc. The user terminal then transmits substantially the same request (1011) for hyperlink to the server as for Scenario B, indicating the selected voicemail and optionally the social site selected for posting. The server (300) then returns substantially the same hyperlink in communication (1012) for scenario A as it would have done for scenario B. The user terminal then logs in to social site server (1000) using the credentials stored in user terminal (1010) and posts the hyperlink to the social site server at a predetermined webpage location for that site, for example, in the case of Facebook, to the user's “status” edit box. Thus social site login credentials need never be provided by user terminal (1010) to server (300), simplifying the procedure for registering with server (300) and avoiding storing private information in a place where a security breach could cause its loss.

Thus whenever a message is shared by posting elsewhere a hyperlink to it on the inventive server in the manner described above, the recipient is directed to the inventive server upon clicking on the link. That initiates the downloading of a computer software object that will be executed by the target platform's web browser to further download the audio file which will be played on some suitable player such as Windows Media Player, as invoked by the target platform's browser. At the same time, the downloaded computer software object may provide the inventive server the opportunity to deliver revenue-generating advertisements in an unobtrusive pop-up box, or in the text section of the browser window, which provides a source of revenue that allows subscriptions to the inventive voicemail aggregation service to be kept to a minimum value or even zero. Further revenue opportunities for the provision of more advanced service options are identifiable by reference to the feature list that can be offered by the inventive system, which is reproduced below.

The Voice Mail Aggregation System will aggregate voice mail from diverse repositories into a central warehouse. The system is comprised of 4 components:
(1) Voice mail system interface—Used to pull voice mails from third party systems including:
   (a) Visual Voice Mail Servers
   (b) Voice mail systems provided by voice mail service companies
   (c) Voice mail systems provided by carriers
   (c) Digital voice mail machines on private lines
   (e) Analog voice mail machines on private lines
(2) Voice Mail Message Repository:
   Stores diverse messages in a common file format
(3) Voice Mail management system—organizes and provides access, security and searching
(4) Voice Mail User Interfaces—Provides for subscribers the access and control interfaces
   (a) Required to listen to saved messages
   (b) Required to listen to posted messages on social media

The Voice Mail Aggregation System will provide a comprehensive feature set to subscribers including:
(1) Ability to pull voice mails from many systems into a single repository
(2) Ability to access (hear or transcribe) voice mails
(3) Ability to sort, search, save, store and otherwise manage the collection of aggregated voice mails in a manner similar to email messages pulled from diverse mail systems
(4) Ability to group mail-boxes from multiple subscribers and manage messages as the group
(5) Ability for group members to access each other's messages
(6) Ability for group members to publish voice messages to group members
(7) Ability for subscriber to publish to a set of subscribers
(8) Ability to share messages with other subscribers
(9) Ability to post messages to social media
(10) Ability to secure messages from access by other group members
(11) Ability to impose a security hierarchy within groups (parental controls)
   (a) Preview before release
   (b) Block from view
(12) Ability to store messages for unlimited period of time
(13) Ability to recover deleted messages
(14) Ability to rank or prioritize messages for viewing
(15) Push voice mails to third party voice mail systems
(16) Ability to retract voice mails from social media
(17) Ability to invoke various voice quality enhancement processes

Subscriptions

Personal (Free)—Subscriptions include aggregated voice mail for single subscriber. Unlimited number of messages stored for 12 months. Allows posting to social media

Family (Free)—Subscriptions allow aggregated voice mail up to 6 family members to function as a group and includes parental security features to manage messaging, review, retrain or block messaging. Unlimited number of messages stored for 12 months. Allows posting to social media

Business (Free)—Subscriptions allow a business to maintain a corporate message repository to comply with legal requirements of storage and preservation of messages and to allow security to keep messages confidential, public, semi-private, etc. Post to subscriber sets, post to non-subscribers, post to group. Unlimited number of messages stored for 12 months. Allows posting to social media.

Gold subscription upgrade (Paid)—Allows the other three basic subscriptions to be upgraded to provide for unlimited voice mail storage duration and enhanced management features. No Ads.

It may be understood from the above specification that the inventive system envisions many features that are not available on normal voicemail systems.

For example, although the possibility is known in the prior art to establish a common voicemail box for a group of telephone users, such as a group of people who may be working on a common project, this facility was only available when the telephones concerned were extensions on the same PABX. Using the voicemail aggregation server of the current invention however allows such groups to be formed when they are geographically widely dispersed and use different telephone systems and carriers.

Another feature that can be provided on the inventive voicemail aggregation server is to allow each registered user to store a list of contacts. In effect, this is a remote storage facility for contact information that is often stored in a mobile phone's memory. A fast way for the user to load the contact information to the server is thus simply to select an offered option to upload his contact list from his mobile phone to his personal area on the inventive server. Moreover, a hierarchical privacy paradigm can be implemented as on Facebook, but with regard to telephone contact information, namely, the user may designate that a specific contact may be viewed only by his “friends”, or only by his “close friends”, by everybody or by nobody. To manage and use this feature, the server may provide web access to registered users to search for people by name or telephone number.

FIG. 2 shows a simplified block diagram of the inventive server (300). It shall be understood that boxes identified by numerals can represent hardware modules, software modules or a combination of hardware and software.

Servers are standalone computers than run continuously without human intervention to provide a function to remote user terminals via the Internet. As such, they do not necessarily have keyboards and displays, except as may be needed for maintenance or updating. A server may have many times the processing power of a typical home PC and in particular may have very high capacity communications interfaces. A server may also comprise an array of many such processors interlinked to achieve the desired capacity.

For the purposes of implementing the invention, a key feature of the inventive server (300) is the use of adapters (301A,301B . . . 301E), which are primarily implemented in software, but which may also employ hardware interfaces.

Each adapter is configured to interface with one known voicemail system. For example, one adapter may interface with and be programmed to navigate through a landline telephone voicemail system such as the ATT-like system used herein as an example of a voice prompt system, and therefore may have a wireline telephone interface. Alternatively, it may have a VoIP interface with Skype-like software for performing the same function via the Internet. Different Landline telephone service providers will likely require different adapters to navigate their respective voice-prompt systems. For example, there could be a Verizon adapter, an ATT adapter, a Time-Warner adapter, a T-mobile adapter, an adapter to a subscriber owned answering machine or an adapter that enlisted the support of a user's mobile phone to retrieve voicemails from any system. Although Time Warner delivers telephone services by cable, along with TV and Internet service, the subscriber is reached by dialing a regular landline number. Adapters configured to automatically pull voicemails from existing voicemail services without participation by the user or user terminal were denoted above as “the second implementation”, while adapters that enlisted the help of the user terminal were denoted above as “the first implementation”.

Although a number of different adapters are required, the number of different hardware units required can be much smaller, as the adapters are implemented by having different software modules that are only loaded into executable memory when required. Such modules can form part of a Dynamically Linked Library routine or DLL. Thus when accessing one carrier's voicemail system, a software module adapted to that system is loaded and activated and uses the same hardware connection to a telephone line or Internet access as when a different software module is loaded and activated to access a different carrier's voicemail system. One high speed Internet connection can in fact support simultaneous access using different software adapters to many different carriers' voicemail systems.

Another type of adapter is one which communicates with a subscriber's smartphone via the Internet, to enlist the support of the smartphone in collecting voicemails, as was denoted “the first implementation” above. It is helpful to offload parts of this operation to the multiplicity of subscribers' smartphones, thus relieving the server of some call initiation load. To enlist the support of a smartphone, the inventive server comprises “App” store (302) which stores software, adapted to different makes of cellphone if necessary, that is downloaded over the Internet to the subscriber's cellphone upon registration. “Apps” may also be stored that are adapted to run on a user's PC, Laptop, Ipad or Tablet. One advantage of enlisting the support of the user terminal in aggregating voicemails is that, when the user terminal is switched on and registers with a network, it may receive notifications that new voicemails are available, thus obviating the need for periodic polling. The inventive App on the user terminal can intercept these notifications and either automatically pull the voicemail from the voicemail system and simultaneously or later, after storing it, transmit the stored message to the voicemail aggregation server, or else, via operation of the App, merely pass the notification to the voicemail aggregation server to cause it to retrieve the message, thus obviating the need for the server to perform polling of that voicemail system and reducing the airtime minutes used by a mobile phone.

Voicemail message server (303) is a software module that implements the user features outlined in the above specification for the service, generating all web pages that can be publicly or privately accessed, all active links thereon, performs storage of voicemails and delivery of advertisements when active links are clicked. The offline processing described above to partition voicemail replays into individual messages may logically be performed by each adapter, as it is likely that the algorithm will be somewhat different for different telephone carriers, due to their use of different voice prompts and voicemail system state diagrams.

In addition, the voicemail server can be caused by a subscriber to perform various voice quality enhancement processes upon a stored digital voice message file. For example, the following processes could be invoked:
(1) Changing or levelling the volume level across a stored message;
(2) Reducing background noise by spectral subtraction (a process known in the art which is not further described here) or any other method;
(3) Pausing, partially rewinding and replaying a section;
(4) Emphasizing or de-emphasizing high or low frequencies using for example a graphical equalizer,
together with any other processes that are known in the prior art of acoustic processing or which may be specifically developed.

Internet communications interface (304) is a high capacity Internet communications interface that allows the establishment of very many simultaneous connections of different types, including delivering web pages to browsers, communicating with Skype-like local concentrators, downloading Apps to smartphones or PCs and collecting digital voice recordings from voicemail systems to be processed in an appropriate adapter. It may also communicate via the Internet with a central Ad server such as provided by Google.

Another type of adapter can provide interfaces with different answering machines, if that is the method the user has elected to receive voicemails at a location served by a landline or cable service. In the case where an answering machine can not be actuated remotely to replay voicemails, the invention contemplates solving the problem by offering the user a new hardware product to replace his old answering machine, which is also a feature of the current invention.

Now that computers, home networking and suchlike have become so economic, it is possible to contemplate every home appliance such as TV, dryer, refrigerator, even down to the toaster have a connection to the internet via a wired (Ethernet) or wireless (WiFi) home network, or via a direct telephone connection using DSL, or an internet connection using a cable modem. The general term coined for such devices is “Web Appliance”. The inventive answering machine that would be offered in this case falls under the general category of a “Web Appliance”. The inventive voicemail aggregation and sharing server described herein is also considered to be a web appliance, and represents one way to implement the inventive voicemail aggregation device, in that case, by an apparatus that serves a large number of registered users.

Web appliances may communicate one to the other, providing their IP addresses are known to each other and they are equipped with suitable software to communicate. Thus one or more web-appliance answering machines associated with different telephone numbers belonging to the same or different subscribers can 1010 communicate with each other or with a server web-appliance to jointly implement a voicemail message aggregation function for a subscriber or group of subscribers. This implementation of an inventive voicemail aggregation apparatus may be regarded as a distributed, rather than centralized solution.

In general, in the expectation that the user already has either a DSL or cable modem with an Ethernet connection, the inventive web-appliance answering machine product can be provided with an Ethernet or WiFi connection to the modem and pass on one or more Ethernet connections to computers, wireless routers or other appliances by performing a router function itself. In addition, it can have a wireline interface to a telephone jack, and software to automatically answer a telephone call that is not answered after a predetermined number of rings. In the case the user has a DSL subscription for obtaining internet access, the envisaged web appliance answering machine would only need connection to a telephone jack and would internally contain the filter necessary to separate DSL signals from telephone voiceband signals and loop-disconnect signalling signals. This device is activated upon detecting ringing, and when the call is not answered after a predetermined number of rings, may issue a pre-recorded greeting and voice prompt to the caller to leave a message. The message may be stored locally prior to forwarding it to the inventive voicemail aggregation server, or else it may forward it simultaneously over the web, using DSL for example, thus collecting voicemails from the wireline and forwarding them directly over the Internet to the inventive server (300), being effectively a remote extension of one of the adapters (301), e.g adapter 301E. The voicemails so collected are retrievable using the user's PC or smartphone by logging into the appropriate web page provided by inventive server (300), or alternatively by dialling a number using a Plain Ordinary Telephone. An advantage of such an answering machine device is that it may capture any signalling from the telephone carrier that is provided only to the subscriber's telephone outlet, such as caller identification. It may be realized that such a function can also be provided by a PC having a telephone jack, as was common in the days of dial-up modems, and having the usual functions that were available for dial-up modem use such as ring detection, auto-answer and programmable signal processing of the received voiceband signal. In the voicemail application the signal processing would be performed to record the voicemail rather than to decode a modem signal.

Of course a user may not desire to leave his computer switched on all day as an advanced answering machine. Thus a much simpler, smaller, lower power and lower-cost product may be envisaged. Such a device would be so infrequently powered up, that it could operate from an internal battery kept charged by drawing a few milliamps from the telephone line, and so would be self-powered.

Alternatively, a DSL or cable modem or both can be combined with the answering machine functionality, a WiFi access point, an Ethernet router and a wired or cordless telephone handset to provide a home appliance with multiple functionality in a single unit, replacing the multiplicity of separate units used today, each requiring their own wall transformers for power and own cable to a telephone jack or cables to interconnect them.

A product as described in the previous paragraph can in its simplest form be an electronic unit having only a connection to a telephone jack. The telephone jack allows both voiceband signals and normal telephone signalling as well as DSL signals to be communicated to or from the networks. In one mode of operation as was just described above, a call received on the telephone line which is still unanswered after a predetermined number of rings is directed to voicemail. Either the inventive product issues a pre-recorded greeting and records the voicemail before passing it to an associated voicemail aggregation server over the internet using the DSL signals, or else it communicates in real time with the voicemail aggregation server using DSL, the voicemail server issuing the prerecorded greeting and receiving the voicemail for recording immediately afterwards, the inventive product merely acting as a relay.

FIG. 4 shows the internal elements of this simplest form of web-appliance answering machine, which only connects to a telephone jack. In some cases it may be used so infrequently that the poser supply circuit PSU (860) can comprise a small battery that is trickle charged by drawing only a milliamp or so from the 48 volt telephone line supply as well as the greater current that is required to be drawn to signal the off-hook condition when making or receiving a call. In other cases where the device is used more often, for providing a computer with DSL service for example, it may require a wall transformer to power PSU 860. PSU 860 provides all the voltages necessary to power loop disconnect interface (830) as well as the other elements. DSL filter (810) is a band-dividing filter that separates the telephone audio and loop disconnect signalling from the much higher frequency DSL signals. The separated DSL signals are passed between the DSL modem (820) and the filter. The DSL modem decodes recovered DSL signals to provide digital data from the internet to processor (850). Conversely, digital data for transmission to the internet is output from processor (850) to modem (820) for conversion to DSL signals. Since it is not possible to connect two DSL modems to the same telephone line, if the subscriber desires DSL internet access for a computer, web-appliance (800) can conveniently also provide an ethernet interface (870) for connection to a PC for example. Alternatively it can connect to a WiFi base station, which, in a more advanced web-appliance, could be built into appliance (800) to provide higher functionality.

Telephone signals separated by DSL filter (810) are connected to loop disconnect interface (830). Loop disconnect interface (830) may include a hybrid transformer or electronic hybrid to separate incoming and outcoming audio signals that exist on the same 2-wire line. Loop disconnect interface (830) also includes ringing detection and a circuit to draw the required off-hook current during a call. Processor (85) controls the off-hook current to signal on/off hook and maybe also pulse dialling. More usually however, such devices employ tone dialling using DTMF tone pairs. Processor (850) receives a ringing indication from the ringing detector and counts the number of rings. When the call goes unanswered after a predetermined number of rings, the processor issues a voice greeting to the caller inviting the caller to leave a message. The voice greeting may be prestored in digital form in processor memory (850) or else may be fetched in real time from a remote server via the internet using the DSL connection simultaneously. The digitally encoded greeting is then output though Digital To Analog converter (840) to the outgoing audio line of loop disconnect interface (830). If the caller leaves a voice message, the incoming audio from loop-disconnect interface (830) is digitized by A to D converter (840) and passed to processor (650) where is may be stored locally in memory, or passed to a remote server or other web-appliance via the internet using DSL modem (820), or stored or buffered temporarily in memory (850) before passing to a remote device.

If voicemails are stored locally, a user may access the voicemails using any computer or smartphone. If the computer is connected to ethernet interface (870), no internet access is necessary, the web-appliance (800) having its own IP address by which the user's PC can access a webpage showing the stored Voicemail list. Moreover, the user's computer can access via the internet any other web-appliance (800) that he is authorized to access, in order to see voicemails received on another telephone number located elsewhere. There is no clear limit to the number of telephones, voicemails to which can be aggregated in this way. The user can select any voicemail stored on any web-appliance and choose to save, listen-to, rewind, replay, quality enhance or delete it, or post a link to it on social media. To allow the latter, web-appliance (800) would be configured to present both a public and a private interface with the internet. It may be realised that, providing web-access to information stored in web-appliance (800) is effectively affording it some of the characteristics of a web-server, except that its capacity to handle multiple-simultaneous accesses by a large number of users is more limited than a typical web-server, due to the limited data rate provided by DSL, or by a cable modem, whichever is used.

One web-appliance, which may be another single-subscriber web-appliance (800) or a multi-user user web-server, may be designated as the master unit and others may be designated to be slave units. The master unit may collect and store all voicemails received at all slave units thereby acting as a voicemail aggregation device. The master unit can be accessed wirelessly by a smartphone for example. Even when there is no master unit and all units store their own voicemails, a smartphone App can be provided that pulls up the information from all such web-appliances belonging to the subscriber in a single display, by accessing each over the internet using their unique IP addresses. The smartphone user may then click on any voicemail to download it from the relevant web-appliance (800)

In a second mode of operation of web-appliance (800), instructions can be received over the internet via DSL to cause the unit to place a telephone call using the analog telephone line. Thus, with a matching App on a mobile phone, PC or other suitable user terminal, a user who is remote from home can effectively use his terminal to make a call from his home phone line, or even remotely answer a call to his home phone line without the delay of call forwarding. Such a device can also be considered to be a remotely located part of one type of adapter for voicemail collection, the remaining part being located at the inventive voicemail aggregation server's site as in the arrangement of FIG. 2.

As was stated above, the inventive voicemail aggregation server is also considered to be a web appliance. Conversely, any web appliance with a suitably programmable processor can be configured to implement a voicemail aggregation and sharing server according to this invention as just outline above. For example, a Personal Computer with an Internet interface, and if necessary an interface with a telephone network, which can be of the conventional loop-disconnect form or can be a Voice-over-IP telephone interface, both of these providing signalling signals indicative of ringing or of a telephone being taken off hook, can be programmed to aggregate voicemails from various telephones, including telephones having voicemail services provided by different, unrelated carriers. Alternatively the inventive web-appliance answering machine (800) can be configured to be capable of performing the same function. Either the web-appliance answering machine or a personal computer can be networked over the Internet with other similar devices owned by the same subscriber or different cooperating subscribers to aggregate voicemails from the associated telephones and make them available for display, replay, deletion or sharing via a social site. Thus the inventive voicemail aggregation and sharing server and service can be implemented entirely on subscriber-owned equipment by installing software configured to implement the invention. For example, a subscriber having telephone subscriptions in different countries such as France, Japan and the United States for example, each associated with fixed telephones installed there, can acquire web-appliance answering machines (800) or Personal Computers with inventive software installed and locate them at the location of the telephones, the devices then being networked via the internet to aggregate voicemails for display, deletion, replay or sharing using a personal computer, smartphone or other user terminal located anywhere in the world where Internet access is available.

While time and space prevents a detailed description of all possible implementations of the invention or of all possible adapters that may be required to operate with all telephone and cellphone service providers that exist, the total number is finite and it is believed that sufficient detail has been provided in the examples above for a person of normal skill in the art to construct adapters configured to untrap voicemails from any voicemail or telephone system. Such persons skilled in the art may make many variations in the way that an inventive server (300) operates or presents its features to a registered user without departing from the spirit and scope of the invention as described by the attached claims.

We claim:

1. An improved voicemail aggregation device for aggregating voicemails from different telephonic systems, comprising:
At least two adapters, each adapted to facilitate navigation through the voicemail retrieval systems of a respective one of a corresponding at least two different telephone service providers;
A server computer, connected to said adapters by a first hardware or software interface to receive retrieved voicemails and store the retrieved voicemails in digital audio form in memory, and connected to the Internet by a second hardware or software interface to provide access to registered clients, and
Software installed on said server computer to handle access to the server via the Internet by said registered clients and for displaying on user terminals of said clients a list of stored voicemails including identifying information for each voicemail.

2. The improved voicemail aggregation device according to claim 1 further including:—
An Applications Program Store for holding software modules constructed to execute on different types of user terminal and operating system used by said registered clients, and which may downloaded from said Applications Program Store by said clients to their respective user terminals upon registration, said software modules being configured to communicate with said server computer periodically to assist said adapters in retrieving voicemails from respective telephonic service providers' voicemail systems, to retrieve lists of stored voicemails for display and to retrieve said digital audio voicemail files for replay on the user terminal

3. The improved voicemail aggregation device according to claim 1 further including:—
An Applications Program store for holding software modules constructed to execute on different types of user terminal and operating system used by said registered clients, and which may downloaded by said clients to their respective user terminals upon registration, said software modules being configured to communicate periodically thereafter with said server to assist said adapters in retrieving voicemails from respective telephonic service providers' voicemail systems, to retrieve lists of stored voicemails for display, and to provide to the subscriber a convenient man-machine-interface to select to view, listen to or quality-enhance selected voicemails and to select to share selected voicemail messages with others by posting links to said selected voicemail messages generated by said improved voicemail aggregation device to other internet sites.

4. A fixed, portable or mobile communications and computing device configured to facilitate the sharing of a voicemail by posting a link to said voicemail at an ad-hoc selected location on an ad-hoc selected website, comprising:
A web browser installed on said computing device for navigating to said ad-hoc selected location on said ad-hoc selected website, and
An editor software program installed on said computing device configured to allow the user to compose a message for posting to said ad-hoc selected location on said ad-hoc selected website, the editor furthermore having a toolbar with an “Insert” option button, clicking of which displays a list of optional media objects available to insert, wherein one of the optional media objects is indicated to be a link to a voicemail audio file stored on a remote voicemail aggregation server.

5. The device of claim 4, in which said editor is configured such that, upon selecting the voicemail insert option, said computing device is caused:
(a) To communicate with said remote voicemail aggregation server to retrieve from the server a list of available voicemails, said list being displayed in a temporary pop-up window to allow the user to select a voicemail from the list, a link to which is to be inserted, and
(b) upon the user selecting a voicemail to insert, to communicate with said voicemail aggregation server to receive a character string representing a hyperlink to the web-location or IP address on said server of a pointer to a software object in said server's memory via which the selected stored voicemail audio file may be reached for retrieval and replay.

6. A method of controlling access by third parties to audio files of voicemails left by second parties for a first party and stored on a web server, links to which have been posted on one or more websites, comprising the steps of:—
Generating a pointer to a software object in said web-server's computer memory separately for each of said one or more websites to which said first party has indicated a link to the selected voicemail shall be posted, the selected voicemail being retrievable via said pointer;
generating a hyperlink to said pointer and transmitting said hyperlink to the user terminal of said first party for insertion into a message to be posted on said indicated website, and
changing the pointer generated for a specific website to point to something other than said voicemail when said first party indicates that he no longer wishes the voicemail to be retrievable by a third party by clicking on the posted hyperlink on said specific website.

7. The method of claim 6 in which said software object in computer memory is a program written in a browser-executable language that, when downloaded to a third party's user terminal and executed by a browser installed thereon:
(a) downloads said selected voicemail as an audio file and initiates its replay using a media player to said third party, and
(b) downloads at least one revenue-generating advertisement and initiates its display to said third party while said voicemail audio file is replaying.

8. A method of providing a voicemail aggregation and sharing service to registered users, the service being at least partly funded by delivering revenue generating advertisements, comprising the steps of:
Configuring an internet server to retrieve voicemails left for one or more first parties by one or more second parties from the voicemail systems of different telephonic service providers and storing them as digital audio files;
Providing via the internet a webpage whereby one of said first parties can view on a suitable user terminal voicemails left for him on any telephone that he has designated, including telephones served by different telephonic service providers;
Providing an Applications program that can be downloaded from said internet server to said user terminal for execution thereon to facilitate the insertion of links to selected ones of said stored digital audio files in messages composed by said first party, the messages being intended to be viewed by one or more third parties on a third party's user terminal, and
Configuring said internet server further such that, upon one of said third parties viewing one of said messages having an embedded link to one of said stored digital audio files representing a voicemail left by a second party for a first party and upon the server detecting that said third party has clicked on said embedded link, downloading the selected digital audio file from said internet server to said third party's user terminal and replaying the audio file simultaneously with displaying on the screen of the third party's user terminal at least one of said revenue-generating advertisements.

9. A web appliance for facilitating the untrapping of voicemails from a telephone network, comprising:
A first interface with said telephone network for placing and receiving calls, transmitting and receiving voiceband signals in analog or digital form and for the transmission and reception of telephone system signalling, including ringing and off-hook detection;
a second interface for transmitting and receiving digital data over the internet, and
a programmable processor configured by stored software to generate or respond to signalling from said telephone network interface, to process said received voiceband signals and telephone system signalling to create in response thereto digital data representing said untrapped voicemails in digital audio form for transmission over the internet at the same time or at a later period of time.

10. The web appliance of claim 9 in which said digital data transmitted or received over the internet using said internet modem comprises communication in digitally coded form of said voicemails that have been untrapped from the telephone network.

11. The web appliance of claim 9 in which said digital data transmitted or received over the internet using said internet modem comprises communication with a remote voicemail aggregation server for storing voicemails that have been untrapped from said telephone network in said remote voicemail aggregation server.

12. The web appliance of claim 9 in which said first interface with said telephone network is an analog, loop-disconnect interface.

13. The web appliance of claim 9 in which said first interface with said telephone network is a Voice-Over-IP interface.

14. The web appliance of claim 9 in which said second interface for transmitting and receiving data over the Internet uses a DSL modem.

15. The web appliance of claim 9 in which said second interface for transmitting and receiving data over the Internet uses a cable modem.

16. The web appliance of claim 9 in which said programmable processor is furthermore programmed to create said voiceband signals or telephone system signalling in response to digital data received via the internet.

17. A method of providing a subscriber with the ability to aggregate voicemails received at multiple telephones having telephone numbers designated by the subscriber, including telephone numbers served by different carriers or located in different countries, comprising the steps of:—
Providing at the location of each of said multiple telephones a web-attached device acting as an answering machine to pick up calls to that telephone that otherwise are unanswered after a predetermined number of rings, each web-attached answering machine issuing a voice greeting inviting the caller to leave a voice message and then awaiting a message to be recorded;
recording said voice messages when left by callers on at least one of said web-attached answering machines, and
networking said web-attached answering machines together over the internet so that at least one of said web-attached answering machines has the information on all voice messages left for any of said multiple telephones and has access to all of said recorded voice messages.

18. The method of claim 17, further comprising:
configuring at least one of said web-attached answering machines to communicate with the voicemail system of one of said subscriber's mobile phones in order to retrieve a voicemail message left for said mobile phone.

19. The method of claim 17, further comprising downloading and installing application software to one of said subscriber's communications and computing terminals in order to configure said terminal to:—
(a) Communicate with at least one of said web-attached answering machine devices to obtain a list of stored voicemails for display, and
(b) provide said subscriber the option to select any of said displayed voicemails to save, delete, partially rewind, replay, quality-enhance or share by posting to another website.

20. A method of configuring a user terminal having communications and computing capability to display, retrieve, replay or share voicemails left on any telephone collaborating with and designated by the user, including telephones served by different, unrelated telephone service providers, comprising the steps of:—
Providing a voicemail aggregation and sharing server accessible via the Internet;
providing said user with the ability to register for a voicemail aggregation and sharing service using said voicemail aggregation and sharing server;
providing said user with the ability to communicate the telephone numbers of said collaborating and user-designated telephones to said voicemail aggregation and sharing server, including telephone numbers served by said different, unrelated service providers;
providing a software application adapted to run on said user terminal that may be downloaded to said user terminal upon said user registering for said voicemail aggregation and sharing service, the software application being capable of configuring the user terminal to facilitate communication with said voicemail aggregation and sharing server to retrieve and display to the user lists of voicemails stored on said voicemail aggregation server; to enable the user to select any voicemail to save, delete, replay or share, and to provide to said user terminal a hyperlink to a computer object or pointer to a computer object stored in said voicemail aggregation and sharing server, the hyperlink being made available for posting by the subscriber to a user-selected social site, the computer object comprising code to deliver a selected voicemail audio file to a third party who visits the social site and clicks on a hyperlink so posted.

21. The improved voicemail aggregation device of claim 1, further comprising:—
Voice recognition software installed on said server computer adapted to recognize the voice prompts of a particular voice-prompt voicemail retrieval system;
state diagram navigation software responsive to the recognition of voice prompts by said voice recognition software to navigate through said voicemail retrieval system to retrieve voicemail messages, thereby to parse the complete replay of said voice-prompt voicemail retrieval system into individual messages and to extract identifying information including message number and time and date of receipt.
